(19) United States
(12) Patent Application Publication
(10) Pub. No.: US 2026/0038449 A1
(43) Pub. Date: Feb. 5, 2026

(54) BACKLIGHT PANEL COMPRISING LIGHT EMITTING DIODES CONFIGURED TO EMIT LIGHTS WITH DIFFERENT COLORS AND DISPLAY DEVICE COMPRISING THE SAME

(71) Applicant: SAMSUNG ELECTRONICS CO., LTD., Suwon-si (KR)

(72) Inventor: Minhoon LEE, Suwon-si (KR)

(73) Assignee: SAMSUNG ELECTRONICS CO., LTD., Suwon-si (KR)

(21) Appl. No.: 19/203,987

(22) Filed: May 9, 2025

Related U.S. Application Data
(63) Continuation of application No. PCT/KR2025/005437, filed on Apr. 22, 2025.

(30) Foreign Application Priority Data
Aug. 2, 2024 (KR) 10-2024-0103404
Sep. 10, 2024 (KR) 10-2024-0123557

(51) Int. Cl. G09G 3/34

(52) U.S. Cl. CPC G09G 3/3413; G09G 3/3426; G09G 2310/08; G09G 2330/021

(57) ABSTRACT

According to an embodiment, a display device includes a display panel, a backlight panel including light emitting diodes (LEDs) which are configured to emit lights with different colors, the LEDs comprising a first LED and a second LED, pixel control circuitry connected to cathodes of the LEDs, and power circuitry connected to power lines respectively connected to anodes of the LEDs. The power circuitry is configured to apply a first voltage for driving the first LED among the LEDs, to a first power line connected to the first LED among the power lines. The power circuitry is configured to apply a second voltage for driving the second LED among the LEDs, to a second power line connected to the second LED among the power lines. The second voltage is different from the first voltage.

### CROSS-REFERENCE TO RELATED APPLICATIONS

This application is a continuation of International Application No. PCT/KR2025/005437 designating the United States, filed on Apr. 22, 2025, in the Korean Intellectual Property Receiving Office and claiming priority to Korean Patent Application Nos. 10-2024-0103404, filed on Aug. 2, 2024, and 10-2024-0123557, filed on Sep. 10, 2024, in the Korean Intellectual Property Office, the disclosures of each of which are incorporated by reference herein in their entireties.

### BACKGROUND

### 1. Field

The present disclosure relates to a backlight panel comprising light emitting diodes configured to emit lights with different colors and a display device comprising the same.

### 2. Description of Related Art

With the recent development of electronic technology, various types of display devices are being developed and distributed, and demand for large display devices is increasing. The display device may display a color by using a liquid crystal to adjust a transmittance of light. A backlight panel may be generate light output toward a display panel (e.g., a display panel including the liquid crystal) for displaying a color.

The above-described information may be provided as a related art for the purpose of helping understanding of the present disclosure. No argument or decision is made as to whether any of the above description may be applied as a prior art related to the present disclosure.

### SUMMARY

According to an embodiment, a display device may comprise a display panel, a backlight panel comprising light emitting diodes (LEDs) which are configured to emit lights with different colors, and are positioned toward the display panel, pixel control circuitry connected to cathodes of the LEDs, and power circuitry connected to power lines respectively connected to anodes of the LEDs. The power circuitry may be configured to apply a first voltage for driving a first LED among the LEDs, to a first power line connected to the first LED among the power lines. The power circuitry may be configured to apply a second voltage for driving a second LED among the LEDs, to a second power line connected to the second LED among the power lines. The second voltage may be different from the first voltage.

According to an embodiment, a display device may comprise a display panel, a backlight panel comprising a plurality of backlight pixels respectively including light emitting diodes (LEDs) configured to emit lights with different colors, and are positioned toward the display panel, a set of pixel control circuitry respectively connected to the plurality of backlight pixels, and power circuitry connected to a plurality of power lines. The plurality of power lines may include a first power line connected to a first group of LEDs having a first color among LEDs included in the plurality of backlight pixels, and a second power line connected to a second group of LEDs having a second color among the LEDs included in the plurality of backlight pixels. The power circuitry may be configured to apply a first voltage to each of the LEDs in the first group through the first power line. The power circuitry may be configured to apply a second voltage different from the first voltage to each of the LEDs in the second group through the second power line.

In an embodiment, a method of a display device may be provided. The display device may comprise a backlight panel comprising light emitting diodes (LEDs) which are configured to emit lights with different colors, pixel control circuitry connected to cathodes of the LEDs, and power circuitry connected to power lines respectively connected to anodes of the LEDs. The method may comprise controlling the power circuitry to apply a first voltage for driving a first LED among the LEDs, to a first power line connected to the first LED among the power lines. The method may comprise controlling the power circuitry to apply a second voltage for driving a second LED among the LEDs, to a second power line connected to the second LED among the power lines. The second voltage may be different from the first voltage.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a display device according to an embodiment;

FIGS. 2A and 2B are diagrams of a backlight panel included in a display device according to an embodiment;

FIG. 3 is an example timing diagram for describing driving time of LEDs of a backlight panel;

FIG. 4 is a graph illustrating a color range that may be represented by a display device according to an embodiment; and

FIG. 5 is an example flowchart of an operation of a display device according to an embodiment.

### DETAILED DESCRIPTION

Hereinafter, various embodiments of the present disclosure will be described with reference to the accompanying drawings.

The various embodiments of the present disclosure and terms used herein are not intended to limit the technology described in the present disclosure to specific embodiments, and should be understood to include various modifications, equivalents, or substitutes of the corresponding embodiment. In relation to the description of the drawings, a reference numeral may be used for a similar component. A singular expression may include a plural expression unless it is clearly meant differently in the context. In the present disclosure, an expression such as “A or B”, “at least one of A and/or B”, “A, B or C”, or “at least one of A, B and/or C”, and the like may include all possible combinations of items listed together. Expressions such as “1st”, “2nd”, “first” or “second”, and the like may modify the corresponding components regardless of order or importance, is only used to distinguish one component from another component, but does not limit the corresponding components. When a (e.g., first) component is referred to as “connected (functionally or communicatively)” or “accessed” to another (e.g., second) component, the component may be directly connected to the other component or may be connected through another component (e.g., a third component).

The term “module” used in the present disclosure may include a unit configured with hardware and may be used interchangeably with terms such as component, and/or circuit, and the like. The module may be an integrally configured component or a minimum unit or part thereof that performs one or more functions. For example, a module may be configured with an application-specific integrated circuit (ASIC).

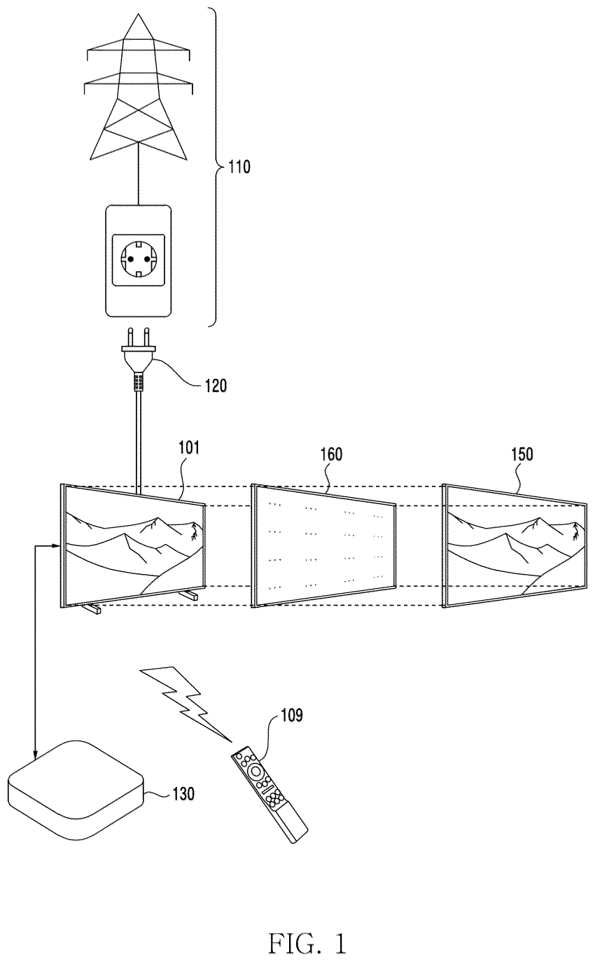

FIG. 1 illustrates a display device 101 according to an embodiment. The display device 101 may be described as an electronic device capable of displaying an image. In the present disclosure, a term “display device” and a term “electronic device” may be used interchangeably. For example, the display device 101 may include a television (TV), a monitor, a computer, a smartphone, a tablet, a portable media player, a wearable device, a video wall, an electronic frame, and the like. Hereinafter, the display device 101 is described as being implemented as a TV, but the embodiments of the present disclosure are not limited thereto.

The display device 101 may be configured to operate by power (e.g., an alternate current (AC) power signal, and/or an alternate current signal) provided from a power system 110. The display device 101 may include a plug 120 (or an electrical cord) configured to be connected to an outlet (or socket, receptacle) located at an end of the power system 110. The plug 120 may be connected to a component (e.g., an AC-DC adapter (or an electrical adapter), or circuitry included in the display device 101) of the display device 101 for power conversion (e.g., a power conversion from an alternate current signal to a direct current (DC) signal (or a direct current power signal).

When (or in a state that) the plug 120 is electrically connected to the power system 110, the display device 101 may execute a function for outputting an image, sound, or a combination of the image and the sound (e.g., a multimedia content), based on the power of the power system 110. When the display device 101 receives information indicating the image and/or the sound, the display device 101 may execute the function, by using the information. The information indicating the image and/or sound may be stored in the display device 101, or received from an external electronic device (e.g., a set-top box (STB)) 130 connected to the display device 101. The display device 101 may include an antenna configured to receive the information wirelessly, or may be electrically connected to the antenna.

The display device 101 may include hardware for receiving a user input (e.g., a user input for switching between a standby mode and a normal mode) for controlling the display device 101. For example, the display device 101 may include a switch (or a button) that is at least partially visible through a housing of the display device 101. For example, the display device 101 may include a touch sensor (e.g., a pressure sensitive touch sensor, and/or a capacitive touch sensor) for detecting a touch input on at least a portion of the housing. The user input may include a direct action (e.g., an action pressing a switch and/or a button, or touching a surface of the housing) of the user on the display device 101. However, embodiments of the present disclosure are not limited to the above examples. In an embodiment, the user input may be identified by an audio signal indicating a speech of the user received through a microphone. In an embodiment, the user input may include an indirect action of the user associated with the display device 101, based on a remote controller 109.

Referring to FIG. 1, the display device 101 may be configured to receive a wireless signal (or an optical signal) of the remote controller 109, based on infrared (IR). The embodiments of the present disclosure are not limited to the above example(s), and the remote controller 109 may be configured to transmit the wireless signal, based on Bluetooth, Bluetooth low energy (BLE), near-field communication (NFC), ultra-wideband (UW B), wireless fidelity (WiFi), WiFi-direct, and/or another wireless short-range communication protocol, and the display device 101 may be configured to receive the wireless signal based on the exemplified wireless short-range communication protocol. In both the standby mode and the normal mode, the display device 101 may be configured to receive the wireless signal of the remote controller 109.

Referring to FIG. 1, the display device 101 may include a display panel 150 and a backlight panel 160. A surface of the display device 101 that may see at least a portion of the display panel 150 may be referred to as a ‘front surface’ (e.g., a front side) of the display device 101. The display panel 150 may include a liquid crystal display (LCD), a plasma display panel (PDP), and/or a plurality of LEDs. The LED of the display panel 150 may include an organic LED (OLED). In an embodiment, the display panel 150 may include electronic paper. In a case that the display panel 150 has a planar shape, the display panel 150 may be referred to as a ‘flat panel display’ (FPD). In a case that the display panel 150 has a curved shape, the display panel 150 may be referred to as a ‘curved display’. In a case that the display panel 150 has a deformable shape, the display panel 150 may be referred to as a ‘bendable display’, a ‘flexible display’, or a ‘rollable display’.

The backlight panel 160 of the display device 101 may be located under the display panel 150 when viewing the display device 101 from the front side. For example, the display panel 150 may be located or stacked on the backlight panel 160. The backlight panel 160 may be configured to emit a light toward the display panel 150. The display panel 150 may include a color filter such as a liquid crystal. In the color filter, the light emitted from the backlight panel 160 may be distorted or filtered. For example, in the color filter, a specific wavelength component of the light may be (selectively or exclusively) outputted to an outside. The display device 101 may visualize an image and/or a video, by (locally) controlling color filters arranged in two dimensions on a plane (or a curved surface) of the display panel 150.

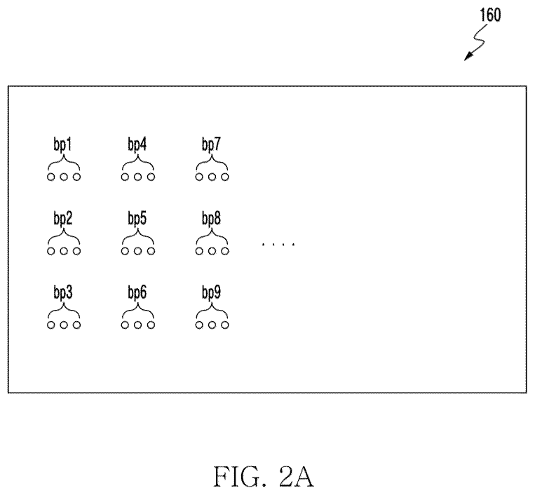

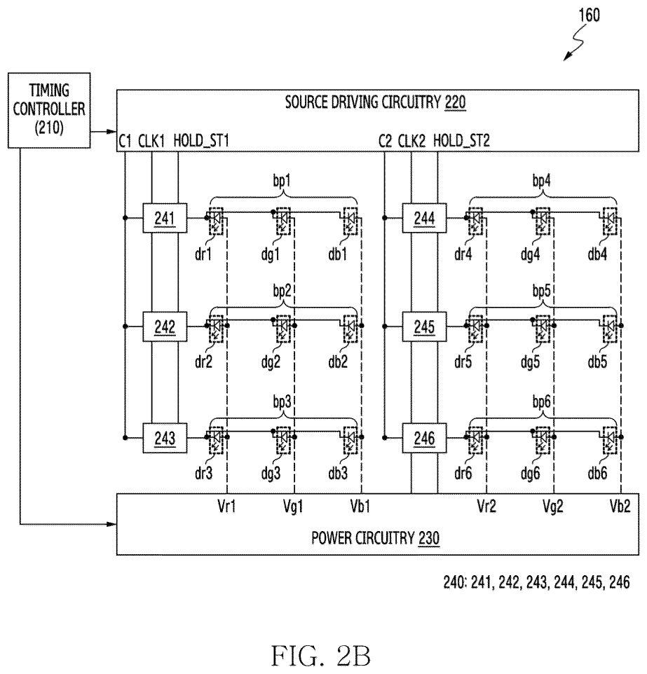

In an embodiment, the backlight panel 160 may be referred to as a ‘light source’ that generates the light emitted from the display device 101 (or the display panel 150). The backlight panel 160 may include light emitting diodes (LEDs) that are configured to emit lights with different colors (e.g., three primary colors of light, such as red, green, and/or blue), and that are positioned toward the display panel 150. In the present disclosure, the backlight panel 160 may be referred to as a ‘back light unit’ (BLU). A locational relationship of the LEDs positioned on a surface of the backlight panel 160 and circuitry for controlling the LEDs will be described with reference to FIG. 2A and FIG. 2B.

According to the embodiment, the backlight panel 160 of the display device 101 may include the LEDs of different colors to widen a range of the colors (e.g., a color area, gradation level, and/or a color reproduction characteristic) capable of being represented by the display device 101. The LED may be configured to emit the light when the LED receives a voltage greater than a threshold voltage (e.g., a forward voltage and/or a bias voltage). For example, the LED may be configured to emit the light when a potential difference between an anode and a cathode is greater than the threshold voltage. When the potential difference between the anode and the cathode of the LED is greater than the threshold voltage, a current may flow through the LED. The voltage applied to the LED and the current flowing through the LED may be associated with intensity of the light (e.g., an amount of light) emitted from the LED. The threshold voltage and/or the forward voltage of the LED may be different according to the light emitted through the LED. For example, a threshold voltage and/or a forward voltage of the LED emitting a red light may be lower than a threshold voltage and/or a forward voltage of the LED emitting a blue light.

In an embodiment, in which the backlight panel 160 includes the LEDs having different colors, applying the same voltage to the LEDs, the backlight panel 160 is inefficient in terms of power consumption determined by multiplying a voltage and a current. For example, since a first threshold voltage of the LED emitting the blue light is higher than a second threshold voltage of the LED emitting the red light, the LED emitting the red light may be driven at the voltage greater than (e.g., greater than or equal to a difference between the first threshold voltage and the second threshold voltage) the second threshold voltage. According to an embodiment, the display device 101 may apply different voltages (e.g., suitable voltages for driving each of the LEDs) to the LEDs in the backlight panel 160 having the different colors. Since the different voltages are applied to the LEDs in the backlight panel 160, power efficiency (or power consumption) of the display device 101 including the backlight panel 160 may be improved.

FIGS. 2A and 2B are diagrams illustrating a backlight panel 160 included in a display device (e.g., the display device 101 of FIG. 1) according to an embodiment. FIG. 2A illustrates a surface (e.g., a front surface and/or front side of the backlight panel 160) of a backlight panel 160 viewed from a display panel (e.g., the display panel 150 of FIG. 1). A plurality of backlight pixels bp1, bp2, bp3, bp4, bp5, bp6, bp7, bp8, bp9, . . . may be positioned on the surface of the backlight panel 160. FIG. 2A illustrates the nine backlight pixels, but the number and/or locations of backlight pixels included in the backlight panel 160 is not limited to the embodiment of FIG. 2A. FIG. 2A illustrates the backlight panel 160 in which three backlight pixels are positioned in a column direction, but embodiments are not limited thereto.

The backlight pixel may include LEDs configured to emit lights of primary colors (e.g., red, green, and blue) included in white. In the present disclosure, a backlight pixel may be referred to as a ‘set (or pair or triplet) of LEDs’. For example, each of the plurality of backlight pixels bp1, bp2, bp3, bp4, bp5, bp6, bp7, bp8, bp9, . . . included in the backlight panel 160 may include three LEDs configured to emit red, green, and blue lights, respectively. The backlight pixel including three LEDs (e.g., a red LED, a green LED, and a blue LED) having different colors is exemplarily illustrated, but embodiments of the present disclosure are not limited to the above example(s). For example, the backlight pixel may include the LEDs greater than three, or less than three. For example, in the backlight pixel, at least two LEDs may be configured to emit light with the same color.

Referring to FIG. 2A, the LEDs included in respective backlight pixel may be densely positioned on the backlight panel 160. In order to clearly provide a white light mixed with red, green, and blue, the LEDs included in the backlight pixel may be intensively positioned. For example, a distance and/or spacing between the LEDs included in a specific backlight pixel may be less than a distance and/or spacing between the LEDs included in each of the different backlight pixels. FIG. 2A illustrates an embodiment in which the LEDs included in the specific backlight pixel are (straightly or sequentially) arranged along a row direction, but the locational relationship of the LEDs in the backlight pixel is not limited thereto.

FIG. 2A illustrates an embodiment in which the plurality of backlight pixels bp1, bp2, bp3, bp4, bp5, bp6, bp7, bp8, bp9, . . . included in the backlight panel 160 are arranged in a form of a grid, but a locational relationship of the plurality of backlight pixels bp1, bp2, bp3, bp4, bp5, bp6, bp7, bp9, . . . is not limited thereto. Referring to FIG. 2A, the backlight pixels bp1, bp2, and bp3 may be positioned along the column direction (or a vertical direction of the backlight panel 160). Referring to FIG. 2A, the backlight pixels bp1, bp4, and bp7 may be positioned along the row direction (or a horizontal direction of the backlight panel 160). Distances (or spacing) between the backlight pixels bp1, bp2, and bp3 positioned along the column direction may be the same each other. Distances (or spacing) between the backlight pixels bp1, bp4, and bp7 positioned along the row direction may be the same as each other. Similarly, the spacing in the column direction of the backlight pixels bp1, bp2, and bp3 and the spacing in the row direction of the backlight pixels bp1, bp4, and bp7 may be the same as each other.

In an embodiment of FIG. 2A, the LEDs in the backlight pixel are arranged in a straight line along the row direction, and orders in which red LEDs, green LEDs, and blue LEDs of the backlight pixels bp1, bp2, and bp3 positioned along the column direction may be the same as each other. For example, in a case that the red LED, the green LED, and the blue LED are sequentially located along the column direction (e.g., FIG. 2A illustrates the direction from left to right of the sheet) in the backlight pixel bp1, the red LED, green LED, and blue LED may be sequentially located along the column direction in the backlight pixel bp2 adjacent to the backlight pixel bp1 along the column direction.

In an embodiment, circuitry for controlling the plurality of backlight pixels bp1, bp2, bp3, bp4, bp5, bp6, bp7, bp8, bp9, . . . (included in the backlight panel 160) may be integrally included in the backlight panel 160. In an embodiment, the circuitry for controlling the plurality of backlight pixels bp1, bp2, bp3, bp4, bp5, bp6, bp7, bp8, bp9, . . . may be included in an electronic component and/or a printed circuit board (PCB) electrically connected to the backlight panel 160. The backlight panel 160 may include the plurality of backlight pixels bp1, bp2, bp3, bp4, bp5, bp6, bp7, bp8, bp9, . . . , and may include one or more wires (or conductive wires, wire segments, or cables) for connecting each of the plurality of backlight pixels bp1, bp2, bp3, bp4, bp5, bp6, bp7, bp8, bp9, . . . to the circuitry.

FIG. 2B illustrates a schematic block diagram of the backlight pixels bp1, bp2, bp3, bp4, bp5, and bp6 of FIG. 2A and the circuitry for controlling the backlight pixels bp1, bp2, bp3, bp4, bp5, and bp6. Referring to FIG. 2B, the LEDs (the red LED in the present disclosure) dr1, dr2, dr3, dr4, dr5, and dr6 configured to emit a red light may be respectively included in the backlight pixels bp1, bp2, bp3, bp4, bp5, and bp6. Similarly, the LEDs (the green LED in the present disclosure) dg1, dg2, dg3, dg4, dg5, and dg6 configured to emit a green light may be respectively included in the backlight pixels bp1, bp2, bp3, bp4, bp5, and bp6. Similarly, the LEDs (the blue LED in the present disclosure) db1, db2, db3, db4, db5, and db6 configured to emit a blue light may be respectively included in the backlight pixels bp1, bp2, bp3, bp4, bp5, and bp6.

Referring to FIG. 2B, the backlight pixels bp1, bp2, bp3, bp4, bp5, and bp6 may be respectively connected to each of pixel control circuitries 241, 242, 243, 244, 245, and 246. For example, the backlight panel 160 and/or the display device including the backlight panel 160 may include a set 240 (or a group) of the pixel control circuitry connected to each of the plurality of backlight pixels bp1, bp2, bp3, bp4, bp5, and bp6. For example, in order to control the backlight panel 160 including “n” backlight pixels, the backlight panel 160 may be electrically connected to n pixel control circuitry. For example, the pixel control circuitries and the backlight pixels may be connected 1:1 to each other. In the example, in a case that the backlight pixels include the red LED, the green LED, and the blue LED, a 1:3 connection between the pixel control circuitries and the LEDs of the backlight panel may be established.

The pixel control circuitry connected to the backlight pixel may be configured to receive at least one of a clock signal, a data signal, or a hold signal as a control signal for controlling the pixel control circuitry. The source driving circuitry 220 may be configured such that at least one pixel control circuitry transmits a control signal (e.g., the clock signal, the data signal, and/or the hold signal) for controlling at least one backlight pixel (or at least one LED included in the at least one backlight pixel) to the at least one pixel control circuitry (e.g., the pixel control circuitry included in the set 240). The source driving circuitry 220 may be implemented as an electronic component connected to the backlight panel 160. Embodiments of the present disclosure are not limited to the above example(s), and the source driving circuitry 220 may be implemented on the PCB included in the backlight panel 160.

The clock signal may be transmitted to the pixel control circuitry to indicate timing of receiving the hold signal, which is a digital signal. For example, the timing may be indicated (or directed) by a rising edge or a falling edge of a waveform of the clock signal (e.g., a waveform of a voltage and/or a current). Referring to FIG. 2B, the pixel control circuitries 241, 242, and 243 respectively corresponding to the backlight pixels bp1, bp2, and bp3 may be connected to the source driving circuitry 220 to receive a first clock signal CLK1. Referring to FIG. 2B, the pixel control circuitries 244, 245, and 246, respectively corresponding to the backlight pixels bp4, bp5, and bp6 located along the column direction, may be connected to the source driving circuitry 220 to receive a second clock signal CLK2. The source driving circuitry 220 may be configured to transmit the data signal and/or the hold signal to at least one pixel control circuitry together with the clock signal (e.g., the clock signals CLK1 and CLK2).

The data signal may indicate brightness of an LED to be controlled by the pixel control circuitry receiving the data signal. The data signal may be an analog signal indicating the brightness based on the current and/or the voltage. The embodiments of the present disclosure are not limited to the above examples, and the data signal may be a digital signal indicating the brightness of the LED. In a case of receiving the data signal which is the analog signal, the pixel control circuitry (e.g., the pixel control circuitries 241, 242, 243, 244, 245, and 246 of FIG. 2B) may identify or determine a target current of the LED connected to the pixel control circuitry, by multiplying the current indicated by the data signal by a designated multiple. In a case of receiving the data signal which is the digital signal, the pixel control circuitry may identify the target current from a binary code represented by the data signal. The pixel control circuitry may cause the LED to output a light with the brightness indicated by the data signal, by maintaining or changing the current of the LED to the target current. Referring to FIG. 2B, the pixel control circuitries 241, 242, and 243 corresponding to each of the backlight pixels bp1, bp2, and bp3 may be configured to receive a first data signal C1 from the source driving circuitry 220. The pixel control circuitries 244, 245, and 246 corresponding to each of the backlight pixels bp4, bp5, and bp6 may be configured to receive a second data signal C2 from the source driving circuitry 220.

Referring to FIG. 2B, since all of the pixel control circuitries 241, 242, and 243 receive the first data signal C1, in order to (individually) control the brightness of each of the pixel control circuitries 241, 242, and 243, the source driving circuitry 220 may transmit the control signal (e.g., the first clock signal CLK1 and/or a first hold signal HOLD_ST1) for notifying timing at which each of the pixel control circuitries 241, 242, and 243 receives the first data signal C1 to the pixel control circuitries 241, 242, and 243. Similarly, since all of the pixel control circuitries 244, 245, and 246 receive the second data signal C2, in order to control the brightness of each of the pixel control circuitries 244, 245, and 246, the source driving circuitry 220 may transmit the control signal (e.g., the second clock signal CLK2 and/or a second hold signal HOLD_ST2) for notifying timing at which each of the pixel control circuitries 244, 245, and 246 receives the second data signal C2 to the pixel control circuitries 244, 245, and 246.

The hold signal may indicate timing at which the pixel control circuitry identifies or reads the data signal. The pixel control circuitry receiving the hold signal having a voltage (e.g., a high voltage) indicating a designated digital value (e.g., 1) may identify or obtain the data signal while the hold signal maintains the voltage. By using the voltage and/or the current of the data signal identified while the hold signal maintains the voltage, the pixel control circuitry may identify or check the brightness of the LED connected to the pixel control circuitry. For example, the pixel control circuitry may control the LED so that the LED maintains the identified brightness. For example, the pixel control circuitry may control the LED to output the current corresponding to the data signal to the LED or to allow the current indicated by the data signal to flow to the LED. For example, the pixel control circuitry may operate like a current source connected to an LED to determine the brightness (i.e., intensity of a light emitted from the LED) of the LED. For example, the pixel control circuitry may maintain the brightness of the LED as the identified brightness based on an active matrix (AM) method.

Referring to FIG. 2B, the first hold signal HOLD_ST1 transmitted from the source driving circuitry 220 may be sequentially transmitted (or relayed) to the pixel control circuitries 241, 242, and 243 corresponding to each of the backlight pixels bp1, bp2, and bp3. Similarly, the second hold signal HOLD_ST2 transmitted from the source driving circuitry 220 may be sequentially transmitted (or relayed) to the pixel control circuitries 244, 245, and 246 corresponding to each of the backlight pixels bp4, bp5, and bp6. A HOLD_ST of FIG. 2B may mean “hold start”. For example, in a first time section indicated by the first clock signal CLK1, the pixel control circuitry 241 receiving the first hold signal HOLD_ST1 having the designated voltage (e.g., a voltage corresponding to the digital value 1) may transmit the first hold signal HOLD_ST1 having the designated voltage to the pixel control circuitry 242 connected (along the column direction) to the pixel control circuitry 241 in a second time section after the first time section indicated by the first clock signal CLK1. In the example, the timings at which the pixel control circuitries 241, 242, and 243 sequentially connected along the column direction receive the first hold signal HOLD_ST1 having the designated voltage may be sequentially delayed according to a cycle (or a frequency) of the first clock signal CLK1.

The pixel control circuitry corresponding to a backlight pixel may be connected to cathodes of the LEDs included in the backlight pixel. For example, the pixel control circuitry 241 corresponding to the backlight pixel bp1 may be respectively connected to the cathodes of the red LED dr1, the green LED dg1, and the blue LED db1 of the backlight pixel bp1. Referring to FIG. 2B, the pixel control circuitry 241 may be connected to the cathodes of the LEDs dr1, dg1, and db1 of the backlight pixel bp1 through a control line (or a node).

Referring to FIG. 2B, power circuitry 230 may be configured to provide power to the LEDs included in the backlight panel 160. The power circuitry 230 may be included in the electronic component electrically connected to the backlight panel 160. The embodiments of the present disclosure are not limited to the above examples, and the power circuitry 230 may be implemented on the PCB included in the backlight panel 160. The power circuitry 230 may be connected to a plurality of power lines. The plurality of power lines may be included in any one layer (e.g., a surface where the LEDs are located) of the backlight panel 160 to connect the LEDs in the power circuitry 230 and the backlight panel 160. Each of the plurality of power lines may be connected to a group (or a set) of the LEDs of a specific color. That is, the red LED, the green LED, and the blue LED may be connected to different power lines.

Referring to FIG. 2B, in an embodiment in which the LEDs of the backlight pixel are positioned along the column direction, the pixel control circuitry corresponding to the backlight pixel may be connected to all of the LEDs through a control line extending along the column direction, and the power circuitry 230 may be connected to the LEDs through each of the plurality of power lines located (parallel) along the row direction.

Referring to FIG. 2B, the LEDs of the same color included in each of the plurality of backlight pixels bp1, bp2, and bp3 may be connected to the power circuitry 230 through a power line extending along the column direction. For example, the plurality of power lines connected to the power circuitry 230 may include a first power line connected to a first group of the LEDs (e.g., the LEDs dr1, dr2, and dr3) having a color (e.g., red) among the LEDs (e.g., the LEDs dr1, dg1, db1, dr2, dg2, db2, dr3, dg3, and db3) included in the plurality of backlight pixels (e.g., the backlight pixels bp1, bp2, and bp3). Referring to FIG. 2B, anodes of the LEDs dr1, dr2, and dr3 may be connected to the first power line. The power circuitry 230 may apply a voltage Vr1 to each of the LEDs dr1, dr2, and dr3 in the first group through the first power line.

For example, the plurality of power lines connected to the power circuitry 230 may include a second power line connected to a second group of the LEDs (e.g., the LEDs dg1, dg2, and dg3) having a color (e.g., green) among the LEDs (e.g., the LEDs dr1, dg1, db1, dr2, dg2, db2, dr3, dg3, and db3) included in the plurality of backlight pixels (e.g., the backlight pixels bp1, bp2, and bp3). The power circuitry 230 may apply a voltage Vg1 different from the voltage Vr1 to the second group of the LEDs dg1, dg2, and dg3 through the second power line. For example, the power circuitry 230 may apply a first voltage (e.g., the voltage Vr1) for driving the red LED to the first power line connected to the red LED (e.g., the LEDs dr1, dr2, and dr3). For example, the power circuitry 230 may apply a second voltage (e.g., a voltage Vb1) for driving the blue LED to a third power line connected to the blue LED (e.g., the LEDs db1, db2, and db3). The first voltage and the second voltage may be different from each other. For example, the second voltage for driving the blue LED may be greater than the first voltage for driving the red LED. In the example, the power circuitry 230 may apply the first voltage to the first power line and apply the second voltage greater than the first voltage to the third power line. Similarly, a third voltage for driving the green LED may also be different from the first voltage and/or the second voltage.

For example, the plurality of power lines may include the third power line connected to a third group of the LEDs (e.g., the LEDs db1, db2, and db3) having a color (e.g., blue) among the LEDs (e.g., the LEDs dr1, dg1, db1, dr2, dg2, db2, dr3, dg3, and db3) included in the plurality of backlight pixels (e.g., the backlight pixels bp1, bp2, and bp3). The power circuitry 230 may apply the voltage Vb1 different from the voltages Vr1 and Vg1 to the LEDs db1, db2, and db3 in the third group through the third power line.

Similarly, among the LEDs dr4, dg4, db4, dr5, dg5, db5, dr6, dg6, and db6 included in the backlight pixels bp4, bp5, and bp6, the red LEDs dr4, dr5, and dr6 may be (commonly) connected to a fourth power line. The plurality of power lines connected to the power circuitry 230 may include a fifth power line connected to the anodes of the green LEDs dg4, dg5, and dg6 of the backlight pixels bp4, bp5, and bp6 located along any one direction (e.g., the column direction) of the backlight panel 160. The power circuitry 230 may include a sixth power line connected to the anodes of the blue LEDs db4, db5, and db6 of the backlight pixels bp4, bp5, and bp6. For example, in the sixth power line, the blue LEDs db4, db5, and db6 may be connected in parallel with respect to the power circuitry 230. In summary, the power circuitry 230 may be connected to the power lines respectively connected to the anodes of the LEDs of the backlight panel 160.

Referring to FIG. 2B, the power circuitry 230 and/or the source driving circuitry 220 may be connected to a timing controller 210. The timing controller 210 may be implemented as another electronic component different from the backlight panel 160. The embodiments of the present disclosure are not limited to the above example, and the timing controller 210 may be at least partially included in the backlight panel 160. The timing controller 210 may be electrically (or operably) connected to the source driving circuitry 220 and the power circuitry 230. The timing controller 210 may transmit an electrical signal (e.g., a synchronization signal) for synchronizing the source driving circuitry 220 and the power circuitry 230 to the source driving circuitry 220 and the power circuitry 230. For example, the timing controller 210 may be configured to synchronize timing of the source driving circuitry 220 transmitting the control signal to the pixel control circuitries, and timing of the power circuitry 230 transmitting the power signal (e.g., a direct current (DC) signal for driving an LED) to at least one of the plurality of power lines.

In an embodiment, the timing controller 210 may be configured to control the source driving circuitry 220 to set and/or adjust an amount of light emitted through the LEDs of the backlight panel 160. The timing controller 210 may be configured to calculate or obtain the amount of light, by using an image and/or a video outputted through the display panel (e.g., the display panel 150 of FIG. 1). The amount of light (or a signal indicating the amount of light) may be provided from another circuitry (e.g., main circuitry of the display device) of the display device connected to the timing controller 210. FIG. 2B illustrates the timing controller 210 as a block different from the source driving circuitry 220, but embodiments of the present disclosure are not limited to the above example. For example, the timing controller 210 may be included in the source driving circuitry 220 as a portion of the source driving circuitry 220.

As described above, according to an embodiment, the LEDs of the backlight panel 160 of the display device may be connected to the pixel control circuitry according to an min (e.g., m>n) relationship. In an embodiment of FIG. 2B, the LEDs and the pixel control circuitry may be connected according to a 3:1 relationship. The LEDs may be controlled by a set 240 of pixel control circuitry less than the number of the LEDs. Since the number of the pixel control circuitry is reduced, the display device including the pixel control circuitry may be produced at a relatively low cost. Since the number of the pixel control circuitry is reduced, a length and/or number of a wire required for producing the pixel control circuitry and the backlight panel may also be reduced. For example, a production cost, production time, and/or a yield of the display device may be improved.

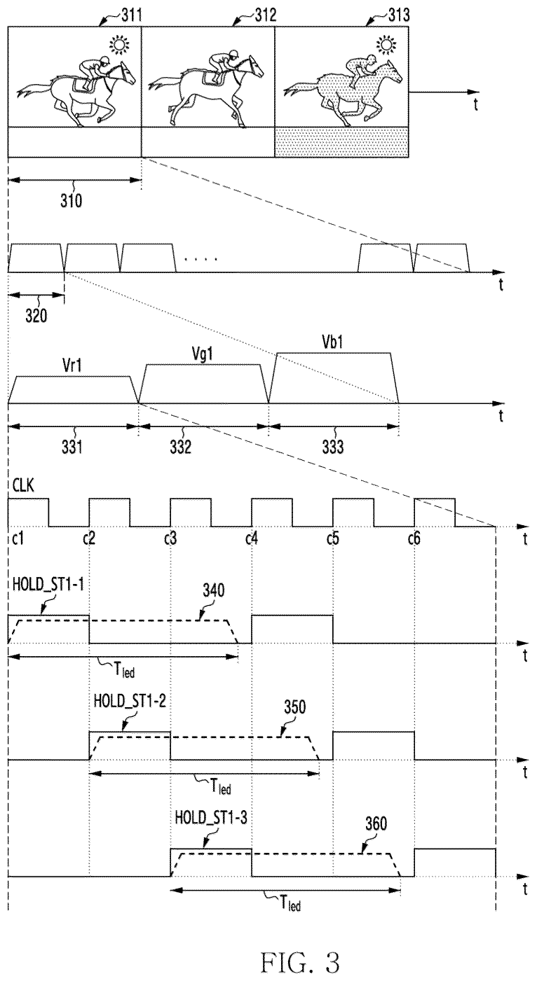

Hereinafter, referring to FIG. 3, an operation of the display device that time-division controls the set 240 of the pixel control circuitry connected to the LEDs will be described in order to control the LEDs in the backlight panel 160 with different colors.

FIG. 3 is an example timing diagram for describing driving time of LEDs of a backlight panel. The backlight panel of FIG. 3 may include the backlight panel 160 of FIGS. 1, 2A, and/or 2B. Referring to FIG. 3, a display panel (e.g., the display panel 150 of FIG. 1), a backlight panel under the display panel, LEDs (e.g., the red LED, the green LED, and the blue LED) included in a backlight pixel (e.g., any one of the backlight pixels bp1, bp2, bp3, bp4, bp5, bp6, bp7, bp8, and bp9 of FIG. 2A and/or FIG. 2B) in the backlight panel, and a timing diagram for describing an operation of pixel control circuitry connected to the LEDs are illustrated.

Referring to FIG. 3, frame images 311, 312, and 313 displayed through the display panel are illustrated. The frame images 311, 312, and 313 may be included in a video played through a display device. The display device may sequentially display the frame images 311, 312, and 313 according to a playback rate represented as frames per second (fps). For example, when displaying the frame images 311, 312, and 313 at 120 fps (or 120 Hz), the display device may display the frame image 311 on the display panel in a time section 310 with a length of 1/120 second (about 8.33 milliseconds). After the time section 310, the display device may display another frame image 312 after the frame image 311 on the display panel.

Hereinafter, an operation of the display device displaying the frame images 311, 312, and 313 according to 120 fps is described as an example, but the display device may operate at a fps (e.g., 12 fps, 24 fps, 30 fps, 60 fps, or another suitable fps) other than 120 fps.

In an embodiment, in the time section 310 in which the frame image 311 is displayed, the backlight pixel may be controlled to repeatedly emit a light (e.g., a white light) according to a cycle (e.g., 8.33 milliseconds/16=0.52 milliseconds) having a length less than the time section 310. For example, the backlight pixel may repeatedly emit the light 16 or more times in the time section 310 in which the frame image 311 is displayed. The number of times the backlight pixel emits the light in the time section 310 corresponding to a frame image 311 may be empirically determined according to whether blinking (or distortion caused by the blinking) of the light provided from the backlight pixel may not be recognized.

Referring to FIG. 3, in a time section 320 in the time section 310, the backlight pixel may emit a white light once. For example, a length of the time section 320 may have a length of about 0.52 milliseconds in a case that the backlight pixel is set to emit the light 16 times repeatedly in the time section 310. Hereinafter, the operation of the display device in the time section 320 may be described. In another time section after the time section 320, the display device may operate similar to the operation described based on the time section 320.

As described above with reference to FIG. 2B, in a case that the backlight pixel includes LEDs of different colors (e.g., the red LED, the green LED, and the blue LED) and the pixel control circuitry (commonly) connected to the LEDs, the pixel control circuitry may sequentially control the LEDs in the time section 320 in which the backlight pixel emits the white light once. Referring to FIG. 3, the time section 320 may include a time section 331 for the red LED, a time section 332 for the green LED, and a time section 333 for the blue LED.

In an embodiment of the display device operating according to the timing diagram of FIG. 3, the LEDs of the three backlight pixels (e.g., the backlight pixels bp1, bp2, and bp3 of FIG. 2B) respectively connected to three pixel control circuitries (e.g., the pixel control circuitries 241, 242, and 243 of FIG. 2B) are connected to power circuitry (e.g., the power circuitry 230 of FIG. 2B) through power lines corresponding to each of the different colors. For example, it is assumed that the red LEDs (e.g., the red LEDs dr1, dr2, and dr3 of FIG. 2B) of the backlight pixels are connected to the power circuitry through a first power line, the green LEDs (e.g., the green LEDs dg1, dg2, and dg3 of FIG. 2B) of the backlight pixels are connected to the power circuitry through a second power line, and the blue LEDs (e.g., the blue LEDs db1, db2, and db3 of FIG. 2B) of the backlight pixels are connected to the power circuitry through a third power line.

Since a threshold voltage required for activating the LEDs varies according to a color of the LEDs, a voltage applied to each of the first power line to the third power line may be (individually or independently) set according to the color of the LED(s) connected to the power line. For example, in the time section 331 of FIG. 3, the power circuitry may apply a voltage Vr1 (e.g., about 2 V) greater than or equal to a threshold voltage of the red LED to the first power line among the first power line to the third power line. In the time section 332 (e.g., the time section 332 different from the time section 331) of FIG. 3, the power circuitry 230 may apply a voltage Vg1 (e.g., about 2.2V) greater than or equal to a threshold voltage of the green LED to the second power line among the first power line to the third power line. In the time section 333 of FIG. 3, the power circuitry may apply a voltage Vb1 (e.g., about 3.3 V) greater than or equal to a threshold voltage of the blue LED to the third power line among the first power line to the third power line. For example, in each of the time sections 331, 332, and 333, the power circuitry may exclusively transmit a power signal (e.g., a direct current signal with a voltage greater than or equal to the threshold voltage) to any one of the power lines corresponding to each of the different colors. Referring to FIG. 3, in the time section 333 in which the voltage Vb1 is applied to the third power line, a voltage of substantially 0 V (or a voltage below a threshold voltage) may be applied to the other power lines (or the remaining power lines) (e.g., OFF).

FIG. 3 illustrates a voltage of a clock signal CLK transmitted by a source driving circuitry (e.g., the source driving circuitry 220 of FIG. 2B) to a set (e.g., the set 240 of FIG. 2B) of the pixel control circuitry. In the time section 331 in which the red LED is activated, the clock signal CLK may have rising edges (e.g., rising edges at a time point c1, c2, c3, c4, c5, and c6) of six times. The pixel control circuitry receiving the clock signal CLK may be configured to detect a data signal and/or a hold signal applied to the pixel control circuitry at the time of detecting the rising edge of the clock signal CLK. Hereinafter, the operation of the three pixel control circuities in the time section 331 for the red LED will be described.

Based on the assumption, the clock signal CLK may be transmitted to three pixel control circuitries (e.g., the pixel control circuitries 241, 242, and 243 of FIG. 2B) connected along a column direction. In the time section 331, the source driving circuitry may transmit a hold signal HOLD_ST1-1. Among the pixel control circuitries, first pixel control circuitry (e.g., the pixel control circuitry 241 of FIG. 2B) directly connected to the source driving circuitry (e.g., the source driving circuitry 220 of FIG. 2B) may receive the hold signal HOLD_ST1-1 transmitted from the source driving circuitry. A hold signal HOLD_ST1-2 of FIG. 3 may indicate a hold signal received by second pixel control circuitry connected to the first pixel control circuitry. A hold signal HOLD_ST1-3 of FIG. 3 may indicate a hold signal received by third pixel control circuitry connected to the second pixel control circuitry.

At the time point c1 in the time section 331, the first pixel control circuitry may receive the hold signal HOLD_ST1-1 based on the rising edge of the clock signal CLK. At the time point c1, the first pixel control circuitry detecting the hold signal HOLD_ST1-1 having a designated voltage (e.g., a high voltage) indicating (or directing) reception of a data signal may receive the data signal (e.g., the first data signal C1 of FIG. 2B) provided from the source driving circuitry at the time point c1. The source driving circuitry may transmit the data signal indicating brightness of the red LED corresponding to the first pixel control circuitry at the time point c1. Referring to FIG. 3, the hold signals HOLD_ST1-2 and HOLD_ST1-3 received by the second pixel control circuitry and the third pixel control circuitry may have a voltage (e.g., a low voltage) different from the designated voltage at the time point c1. Therefore, at the time point c1, the second pixel control circuitry and the third pixel control circuitry do not identify or receive any data signal.

The first pixel control circuitry identifying the data signal at the time point c1 may control the red LED (e.g., the red LED dr1 of FIG. 2B) connected to the first pixel control circuitry during a time section 340 having a length (Tled) after the time point c1. The first pixel control circuitry may control the red LED so that a current indicated by the data signal flows through the red LED. For example, the first pixel control circuitry may maintain the current of the red LED in at least a portion (e.g., the time section 340) of the time section 331 for the red LED. For example, in the time section 340 of the time section 331 for the red LED, the first pixel control circuitry may maintain the current of the red LED in order to maintain intensity of the red LED at intensity associated with the frame image 311 displayed through the display panel. The first pixel control circuitry may include a capacitor for storing the data signal and/or the current indicated by the data signal. In the time section 340, the red LED connected to the first pixel control circuitry may be activated based on the voltage Vr1 applied from the first power line and the current controlled by the first pixel control circuitry. For example, in the time section 340, the red LED connected to the first pixel control circuitry may emit the red light based on the voltage Vr1 and the current adjusted by the first pixel control circuitry.

The first pixel control circuitry receiving the hold signal HOLD_ST1-1 having the designated voltage indicating reception of the data signal at the time point c1 may transmit the hold signal HOLD_ST1-2 having the designated voltage to the second pixel control circuitry at the rising edge (e.g., the rising edge at the time point c2) following the time point c1.

Referring to FIG. 3, at the time point c2, the second pixel control circuitry may receive or detect the hold signal HOLD_ST1-2 having the designated voltage based on the rising edge of the clock signal CLK. The second pixel control circuitry receiving the hold signal HOLD_ST1-2 having the designated voltage may receive a data signal (e.g., the first data signal C1 of FIG. 2B) provided from the source driving circuitry at the time point c2. The source driving circuitry may transmit the data signal indicating brightness of the red LED (e.g., the red LED dr2 of FIG. 2B) corresponding to the second pixel control circuitry at the time point c2. Referring to FIG. 3, the hold signals HOLD_ST1-1 and HOLD_ST1-3 received by the first pixel control circuitry and the third pixel control circuitry may have a voltage (e.g., a low voltage) different from the designated voltage at the time point c2. Therefore, at the time point c2, the first pixel control circuitry and the third pixel control circuitry do not identify any data signal. For example, at the time point c2, the first pixel control circuitry may maintain controlling the red LED corresponding to the first pixel control circuitry based on the data signal received at the time point c1 before the time point c2.

The second pixel control circuitry identifying the data signal at the time point c2 may control the red LED (e.g., the red LED dr2 of FIG. 2B) connected to the second pixel control circuitry during a time section 350 with a length (Tled) after the time point c2. The second pixel control circuitry may include a capacitor for storing the current of the data signal, and may control the red LED, by using the current stored in the capacitor. For example, the second pixel control circuitry may maintain the brightness of the red LED during the time section 350, based on brightness indicated by the data signal at the time point c2. The red LED connected to the second pixel control circuitry may be activated based on the voltage Vr1 applied to the first power line and the current controlled by the second pixel control circuitry during the time section 350.

The second pixel control circuitry receiving the hold signal HOLD_ST1-2 having the designated voltage indicating the reception of the data signal at the time point c2 may transmit the hold signal HOLD_ST1-3 having the designated voltage to the third pixel control circuitry at the rising edge (e.g., the rising edge at time point c3) following the time point c2.

Referring to FIG. 3, at the time point c3, the third pixel control circuitry may receive the hold signal HOLD_ST1-3 having the designated voltage, based on the rising edge of the clock signal CLK. The third pixel control circuitry may receive the data signal (e.g., the first data signal C1 of FIG. 2B) transmitted from the source driving circuitry at the time point c3 when the designated voltage of the hold signal HOLD_ST1-3 is detected. The source driving circuitry may transmit the data signal indicating the brightness of the red LED (e.g., the red LED dr3 of FIG. 2B) connected to the third pixel control circuitry at the time point c3. The hold signals HOLD_ST1-1 and HOLD_ST1-2 received by the first pixel control circuitry and the second pixel control circuitry may have a voltage (e.g., a low voltage) different from the designated voltage at the time point c3. Therefore, at the time point c3, the first pixel control circuitry and the second pixel control circuitry do not identify any data signal. For example, at the time point c3, the first pixel control circuitry may maintain controlling the red LED corresponding to the first pixel control circuitry based on the data signal received at the time point c1, and the second pixel control circuitry may (continuously) control the red LED connected to the second pixel control circuitry according to the brightness indicated by the data signal received at the time point c2.

At the time point c3, the third pixel control circuitry receiving the data signal may activate the red LED (e.g., the red LED dr3 of FIG. 2B) connected to the third pixel control circuitry during a time section 360 with a length (Tled) after the time point c3. The third pixel control circuitry may include the capacitor for storing the current of the data signal. The third pixel control circuitry may control the red LED using the current stored in the capacitor. For example, the third pixel control circuitry may change or maintain a magnitude of the current flowing through the red LED based on the brightness indicated by the data signal at the time point c3. The red LED connected to the third pixel control circuitry may emit the red light having the brightness indicated by the data signal at the time point c3, based on the voltage Vr1 applied to the first power line and the current adjusted by the third pixel control circuitry during the time section 360.

Referring to FIG. 3, the red LEDs connected to the first pixel control circuitry to the third pixel control circuitry may be activated during time sections 340, 350, and 360 of the same length (Tled) in the time section 331 for the red LED. For example, the length of the time sections 340, 350, and 360 may be unified to the length (Tled) so that the red LEDs connected to the first pixel control circuitry to the third pixel control circuitry emit the light of the same brightness.

Referring to FIG. 3, before expiration of the time section 331 for the red LED, the pixel control circuitries may turn off the red LEDs connected to each of the pixel control circuitries. For example, the hold signal HOLD_ST1-1 for deactivating (e.g., turning off) the red LED of the first pixel control circuitry may be transmitted to the first pixel control circuitry at the time point c4 after the time section 340. At the rising edge at the time point c4, the first pixel control circuitry receiving the hold signal HOLD_ST1-1 having the designated voltage indicating the reception of the data signal may receive the data signal provided from the source driving circuitry at the time point c4. The source driving circuitry may transmit the data signal indicating the brightness (e.g., substantially zero brightness) for deactivating the LED (e.g., the red LED connected to the first pixel control circuitry) at the time point c4. The first pixel control circuitry receiving the data signal at the time point c4 may turn off the red LED connected to the first pixel control circuitry.

At the time point c4, the first pixel control circuitry receiving the hold signal HOLD_ST1-1 having the designated voltage indicating the reception of the data signal may transmit the hold signal HOLD_ST1-2 having the designated voltage to the second pixel control circuitry at the rising edge (e.g., the rising edge at the time point c5) following the time point c4. The second pixel control circuitry may detect the hold signal HOLD_ST1-2 having the designated voltage at the time point c5. Therefore, at the time point c5, the second pixel control circuitry may detect the data signal provided from the source driving circuitry. The source driving circuitry may transmit the data signal indicating the brightness causing deactivation of the LED at the time point c5. Based on the data signal transmitted at the time point c5, the second pixel control circuitry may turn off the red LED connected to the second pixel control circuitry.

The second pixel control circuitry receiving the hold signal HOLD_ST1-2 having the designated voltage at the time point c5 may transmit the hold signal HOLD_ST1-3 having the designated voltage to the third pixel control circuitry at the rising edge (e.g., the rising edge at the time point c6) following the time point c5. The third pixel control circuitry receiving the hold signal HOLD_ST1-3 having the designated voltage at the time point c6 may control the red LED connected to the third pixel control circuitry based on the data signal at the time point c6. In a case that the source driving circuitry transmits the data signal that makes the brightness of the LED substantially zero at the time point c6, the third pixel control circuitry may turn off the red LED at the time point c6.

Referring to FIG. 3, all of the red LEDs connected to the three pixel control circuitries may be (sequentially) deactivated in the time section 331 for the red LED after the time point c4. In a case that the LED of a different color than the red LED is turned on in a state in which the red LED is turned on, damage to the LED based on overvoltage and/or overcurrent may be caused. In order to prevent the damage, three pixel control circuitries may be (sequentially) reset from the time point c4.

An example operation in which the first pixel control circuitry to the third pixel control circuitry respectively controls the red LEDs in the time section 331 for the red LED has been described. In the time section 332 for the green LED following the time section 331 for the red LED, the first pixel control circuitry to the third pixel control circuitry may control the green LEDs (e.g., the green LEDs dg1, dg2, and dg3 of FIG. 2B) connected to each of the first pixel control circuitry to the third pixel control circuitry similarly to the operation in the time section 331. In the time section 332, the green LEDs may emit the green lights based on the voltage Vg1 applied to the second power line and the current controlled by the pixel control circuitries (e.g., the first pixel control circuitry to the third pixel control circuitry) corresponding to each of the green LEDs. Since no voltage is applied to the power lines (e.g., the first power line and/or the third power line) corresponding to the red LEDs and the blue LEDs in the time section 332, the red LEDs and the blue LEDs may be deactivated. In the time section 332, the green LEDs may emit the lights during the time section of the same length. Due to a delay in the hold signal received by each of the first pixel control circuitry to the third pixel control circuitry, starting points (or ending points) at which the green LEDs emit the lights may be different from each other. In the time section 332, the green LEDs and the pixel control circuitries respectively connected to the green LEDs may be (sequentially) reset or deactivated.

Similarly, in the time section 333 for the blue LED following the time section 332 for the green LED, the first pixel control circuitry to the third pixel control circuitry may respectively control the blue LEDs connected to the first pixel control circuitry to the third pixel control circuitry, similar to the operation in the time section 331. In the time section 333, the blue LEDs may emit the blue lights based on the voltage Vb1 applied to the third power line and the current maintained by the pixel control circuitries corresponding to each of the blue LEDs. Since no voltage is applied to the power lines (e.g., the first power line and/or the second power line) corresponding to the red LEDs and the green LEDs in the time section 333, the red LEDs and the green LEDs may be turned off. Lengths of the time sections in which the blue LEDs emit the blue lights may coincide with each other. In the time section 333, the blue LEDs and the pixel control circuitries connected to each of the blue LEDs may be (sequentially) reset or deactivated.

Referring to FIG. 3, since all red LED, green LED, and blue LED emit the lights during the time section 320, which is a combination of the time sections 331, 332, and 333, a user looking at the backlight panel including the red LED, the green LED, and the blue LED may recognize white, which is a mixture of the lights, by afterimage of the light. In a case that the display panel is located between the backlight panel and the user, as the white light is filtered in the display panel, the frame image 311 may be visualized. While each of other frame images 312 and 313 following the frame image 311 is displayed, the backlight panel of the display device may repeatedly perform the operation that was performed in the time section 310 in which the frame image 311 was displayed.

In an example case where the red LED, the green LED, and the blue LED of the backlight panel are connected to the same power line, the voltage applied to the power line may be set greater than or equal to the maximum value of the threshold voltages because the threshold voltages for driving the red LED, the green LED, and the blue LED are different from each other. In the case, when the threshold voltage for driving the red LED is 2.0 V, the threshold voltage for driving the green LED is 2.2 V, and the threshold voltage for driving the blue LED is 3.3 V, all red LED, green LED, and blue LED may be activated only when a voltage of 3.3 V is applied to the power line. In the case, a voltage exceeding the threshold voltage for driving the red LED by 1.3 V may be applied to the red LED. In the case, a voltage exceeding the threshold voltage for driving the green LED by 1.1 V may be applied to the green LED.

In other words, in the above case, the red LED and the green LED receive relatively high voltage, even though the red LED and the green LED are activated at relatively low voltage. Since power consumption of the LED is a product of a voltage and a current, the power consumption may be increased inefficiently in the red LED and the green LED that unnecessarily receive a high voltage. In the case, the power consumption of the red LED, the green LED, and the blue LED may be calculated as Table 1.

TABLE 1

| | Voltage | | | |
|---|---|---|---|---|
| | Red LED | Green LED | Blue LED | Total Power |
| Current | 3.3 V | 3.3 V | 3.3 V | Consumption |
| 5 mA | 16.5 mW | 16.5 mW | 16.5 mW | 49.5 mW |

Referring to Table 1, since the red LED, the green LED, and the blue LED all receive a voltage of 3.3 V and a current of 5 mA, a sum of the power consumption of the red LED, the green LED, and blue LED may be 49.5 mW.

According to an embodiment, the display device may include the backlight panel including the LEDs configured to emit the lights with different colors. In order to optimize the power consumption of the LEDs, power of the LEDs may be separated according to the colors of the LEDs. As described above with reference to FIGS. 1 to 3, the LEDs may be classified into groups of LEDs corresponding to a color, and the power lines extending from the power circuitry may be respectively connected to the groups. The power circuitry may apply different voltages to the power lines (e.g., the power lines corresponding to each of the different colors).

For example, since each of the red LED, the green LED, and the blue LED receives different threshold voltages, the sum of the power consumption of the red LED, the green LED, and the blue LED may be calculated as Table 2, even when the red LED, the green LED, and the blue LED receive 5 mA of Table 1.

TABLE 2

| | Voltage | | | |
|---|---|---|---|---|
| | Red LED | Green LED | Blue LED | Total Power |
| Current | 2 V | 2.2 V | 3.3 V | Consumption |
| 5 mA | 10 mW | 11 mW | 16.5 mW | 37.5 mW |

Comparing the Tables 1 and 2, the power consumption of a case in which different voltages are applied to the red LED, the green LED, and the blue LED may be less than the power consumption of a case in which the same voltages are applied to the red LED, the green LED, and the blue LED. Comparing the Tables 1 and 2, the power consumption may be reduced by about 24%.

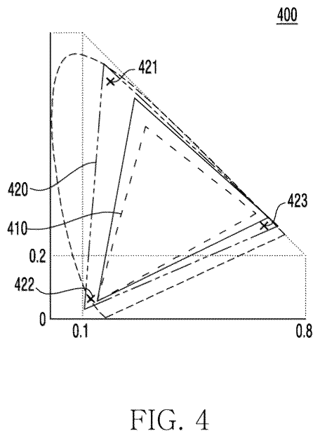

FIG. 4 is a graph 400 illustrating a color range that may be represented by a display device according to an embodiment. FIG. 4 illustrates the graph 400 based on a two-dimensional mapping for a three-dimensional color space of red, green, and blue. The graph 400 may indicate a color range that may be represented by the display device (e.g., the display device 101 of FIG. 1) based on a XYZ color space (or a CIE 1931 color space).

FIG. 4 illustrates a color space 410 of SR GB. According to an embodiment, red LED (e.g., the red LEDs dr1, dr2, dr3, dr4, dr5, and dr6 of FIG. 2B) included in a backlight panel of the display device may output a light of a color corresponding to a point 423 outside the color space 410 of the sRGB. According to an embodiment, green LED (e.g., the green LEDs dg1, dg2, dg3, dg4, dg5, and dg6 of FIG. 2B) included in the backlight panel of the display device may output a light of a color corresponding to a point 421 outside the color space 410. According to an embodiment, blue LED (e.g., the blue LEDs db1, db2, db3, db4, db5, and db6 of FIG. 2B) included in the backlight panel of the display device may output a light of a color corresponding to a point 422 outside the color space 410.

Since the backlight panel includes the LEDs outputting lights having colors corresponding to each of the points 421, 422, and 423 outside the color space 410 of the sRGB, a color space that may be represented by the display device including the backlight panel may be wider than the color space 410 of the sRGB. Referring to the graph 400 of FIG. 4, the display device may display a color included in a color space 420 of Rec.2020 (or ITU-R Recommendation BT.2020) including the points 421, 422, and 423. Embodiments of the present disclosure are not limited to the above example. For example, the display device may display a color included in a color space of Digital Cinema Initiatives-P3 (DCI-P3). Since an image or a video is displayed based on a color space wider than the color space 410 of the SRGB, such as the color space 420, color reproducibility of the display device including the backlight panel may be improved.

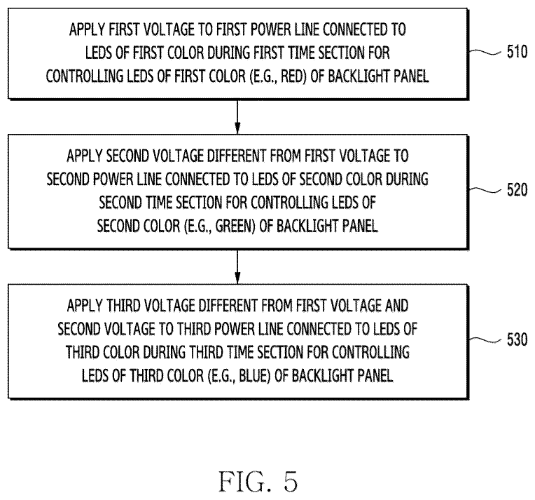

FIG. 5 is an example flowchart of an operation of a display device according to an embodiment. The display device 101 of FIG. 1, the source driving circuitry 220, the power circuitry 230, and/or the pixel control circuitries (e.g., the pixel control circuitries included in the set 240) of FIG. 2B may perform an operation described with reference to FIG. 5. An order in which operations 510, 520, and 530 of FIG. 5 are performed is not limited to an order illustrated in FIG. 5. For example, the display device may perform operations 510, 520, and 530 in a different order from the order illustrated in FIG. 5.

Referring to FIG. 5, in operation 510, according to an embodiment, the display device may apply a first voltage to a first power line connected to LEDs of a first color during a first time section for controlling the LEDs of the first color (e.g., red) of a backlight panel (e.g., the backlight panel 160 of FIG. 2A and/or FIG. 2B). The first time section in which operation 510 is performed may correspond to the time section 331 of FIG. 3. The first voltage of operation 510 may correspond to a threshold voltage for driving the LEDs of the first color, as the voltage Vr1 of FIG. 3. In operation 510, the display device may control the power circuitry to apply the first voltage for driving the LED of the first color to the first power line connected to the LED of the first color among power lines.

While applying the first voltage to the first power line based on operation 510, the display device may control the pixel control circuitries connected to the LEDs of the first color to cause the LEDs of the first color to output lights of the first color. The pixel control circuitry may be connected to the LED of the first color, the LED of a second color (e.g., green), and the LED of a third color (e.g., blue). In the first time section in which operation 510 is performed, since only the LED of the first color among the LED of the first color, the LED of the second color, and the LED of the third color receives the first voltage through the first power line, only the LED of the first color among the LED of the first color, the LED of the second color, and the LED of the third color may output light in the first time section.

Referring to FIG. 5, in operation 520, according to an embodiment, the display device may apply a second voltage (that is different from the first voltage) to a second power line connected to the LEDs of the second color during a second time section for controlling the LEDs of the second color (e.g., green) of the backlight panel. The second time section in which operation 520 is performed may correspond to the time section 332 of FIG. 3. The second voltage of operation 520 may correspond to a threshold voltage for driving the LEDs of the second color, as the voltage Vg1 of FIG. 3. In operation 520, the display device may control the power circuitry to apply the second voltage for driving the LED of the second color to the second power line connected to the LED of the second color among the power lines.

While applying the second voltage to the second power line based on operation 520, the display device may cause the LEDs of the second color to output the lights of the second color, by controlling the pixel control circuitries connected to the LEDs of the second color. In an embodiment in which the pixel control circuitry is connected to all of the LED of the first color, the LED of the second color, and the LED of the third color, only the LED of the second color among the LED of the first color, the LED of the second color, and the LED of the third color may receive the second voltage through the second power line in the second time section of operation 520. Therefore, in the second time section, only the LED of the second color may output the light of the second color among the LED of the first color, the LED of the second color, and the LED of the third color. For example, in the second time section, the LED of the first color and the LED of the third color may be turned off.

Referring to FIG. 5, in operation 530, according to an embodiment, the display device may apply a third voltage different from the first voltage and the second voltage to a third power line connected to the LEDs of the third color during a third time section for controlling the LEDs of the third color (e.g., blue) of the backlight panel. The third time section in which operation 530 is performed may correspond to the time section 333 of FIG. 3. The third voltage of operation 530 may correspond to a threshold voltage for driving the third color, as the voltage Vb1 of FIG. 3. For example, each of the first voltage, the second voltage, and the third voltage of operations 510, 520, and 530 may be set independently or may be different to each other. In operation 530, the display device may control the power circuitry to apply the third voltage for driving the LED of the third color to the third power line connected to the LED of the third color among the power lines.

In an embodiment in which the pixel control circuitry is connected to all of the LED of the first color, the LED of the second color, and the LED of the third color, the pixel control circuitry may (selectively or exclusively) control the LED of the third color in the third time section of operation 530. In an embodiment in which the pixel control circuitry is connected to all of the LED of the first color, the LED of the second color, and the LED of the third color, only the LED of the third color among the LED of the first color, the LED of the second color, and the LED of the third color may receive the third voltage through the third power line in the third time section of operation 530. Therefore, in the third time section, only the LED of the third color among the LED of the first color, the LED of the second color, and the LED of the third color may output the light of the third color. For example, the LED of the first color and the LED of the second color may be deactivated in the third time section.

In an embodiment, a method of reducing power consumption (e.g., power consumption of a backlight panel) of a display device may be required. In an embodiment, a method controlling LEDs of a backlight panel, by using simplified circuitry may be required. As described above, according to an embodiment, a display device (e.g., the display device 101 of FIG. 1) may include a display panel (e.g., the display panel 150 of FIG. 1), a backlight panel (e.g., the backlight panel 160 of FIGS. 1, 2A, and/or 2B) including light emitting diodes (LEDs) which are configured to emit lights with different colors, and are positioned toward the display panel, pixel control circuitry (e.g., the pixel control circuitries 241, 242, 243, 244, 245, and 246) connected to cathodes of the LEDs, and power circuitry (e.g., the power circuitry 230 of FIG. 2B) connected to power lines respectively connected to anodes of the LEDs. The power circuitry may be configured to apply a first voltage for driving a first LED among the LEDS, to a first power line connected to the first LED among the power lines. The power circuitry may be configured to apply a second voltage for driving a second LED among the LEDs, to a second power line connected to the second LED among the power lines. The second voltage may be different from the first voltage. According to an embodiment, the backlight panel of the display device may have reduced power consumption. According to an embodiment, circuitry for driving LEDs of the backlight panel of the display device may be simplified.

For example, the LEDs may include the first LED (e.g., dr1, dr2, dr3, dr4, dr5, and dr6 of FIG. 2B) configured to emit a light with a red color, the second LED (e.g., db1, db2, db3, db4, db5, and db6 of FIG. 2B) configured to emit a light with a blue color, and a third LED (e.g., dg1, dg2, dg3, dg4, dg5, and dg6 of FIG. 2B) configured to emit a light with a green color.

For example, the power circuitry may be configured to apply, to the second power line, the second voltage greater than the first voltage.

For example, the power circuitry may be configured to apply, in a first time section, the first voltage to the first power line. The power circuitry may be configured to apply, in a second time section different from the first time section, the second voltage to the second power line.

For example, the pixel control circuitry may be configured to maintain, in at least a portion of the first time section, a current of the first LED.

For example, the pixel control circuitry may be configured to maintain the current of the first LED to maintain, in the at least portion of the first time section, intensity of the first LED as intensity associated with a frame image displayed through the display panel.

For example, the pixel control circuitry may be connected to the cathodes of the LEDs through a control line.

For example, the backlight panel may include a plurality of sets of LEDs including a set of the LEDs which are connected to the pixel control circuitry. The display device may include a set of pixel control circuitry including the pixel control circuitry. The pixel control circuitry included in the set are respectively connected to the plurality of sets of the LEDs.

As described above, according to an embodiment, a display device may include a display panel, a backlight panel including a plurality of backlight pixels respectively including light emitting diodes (LEDs) configured to emit lights with different colors, and are positioned toward the display panel, a set of pixel control circuitry respectively connected to the plurality of backlight pixels, and power circuitry connected to a plurality of power lines. The plurality of power lines may include a first power line connected to a first group of LEDs having a first color among LEDs included in the plurality of backlight pixels, and a second power line connected to a second group of LEDs having a second color among the LEDs included in the plurality of backlight pixels. The power circuitry may be configured to apply a first voltage to each of the LEDs in the first group through the first power line. The power circuitry may be configured to apply a second voltage different from the first voltage to each of the LEDs in the second group through the second power line.

For example, each of the plurality of backlight pixels may include a first LED configured to emit a light with a red color, a second LED configured to emit a light with a blue color, and a third LED configured to emit a light with a green color.

For example, the power circuitry may be configured to apply, to the first group of the LEDs configured to emit a light with a red color, the first voltage. The power circuitry may be configured to apply, to the second group of the LEDs configured to emit a light with a blue color, the second voltage greater than the first voltage.

For example, the power circuitry may be configured to apply, in a first time section, the first voltage to the first power line. The power circuitry may be configured to apply, in a second time section different from the first time section, the second voltage to the second power line.

For example, each of pixel control circuitry included in the set may be configured to maintain, in at least a portion of the first time section, a current of each of the LEDs included in the first group.

For example, the plurality of power lines may include a third power line connected to, among LEDs included in the plurality of backlight pixels, a third group of LEDs having a third color. The power circuitry may be configured to apply, in a third time section different from the first time section and the second time section, a third voltage to the third power line different from the first voltage, and the second voltage.

For example, each of the pixel control circuitry included in the set may be connected to cathodes of the LEDs included in a corresponding backlight pixel through a control line.

In an embodiment, a method of a display device may be provided. The display device may include a backlight panel including light emitting diodes (LEDs) which are configured to emit lights with different colors, pixel control circuitry connected to cathodes of the LEDs, and power circuitry connected to power lines respectively connected to anodes of the LEDs. The method may include controlling the power circuitry to apply a first voltage for driving a first LED among the LEDs, to a first power line connected to the first LED among the power lines. The method may include controlling the power circuitry to apply a second voltage for driving a second LED among the LEDs, to a second power line connected to the second LED among the power lines. The second voltage may be different from the first voltage.

For example, the LEDs may include the first LED configured to emit a light with a red color, the second LED configured to emit a light with a blue color, and a third LED configured to emit a light with a green color.

For example, the controlling the power circuitry may include controlling the power circuitry to apply the second voltage greater than the first voltage to the second power line.

For example, the controlling the power circuitry may include controlling the power circuitry to apply the first voltage to the first power line in a first time section. The controlling the power circuitry may include controlling the power circuitry to apply, in a second time section different from the first time section, the second voltage to the second power line.

For example, the pixel control circuitry may be configured to maintain a current of the first LED in at least portion of the first time section.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

As described above, although the embodiments have been described with limited examples and drawings, a person who has ordinary knowledge in the relevant technical field is capable of various modifications and transform from the above description. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later.

What is claimed is:

1. A display device comprising:
a display panel;
a backlight panel comprising light emitting diodes (LEDs) which are configured to emit lights with different colors, the LEDs comprising a first LED and a second LED;
pixel control circuitry connected to cathodes of the LEDs; and
power circuitry connected to power lines respectively connected to anodes of the LEDs,
wherein the power circuitry is configured to:
apply a first voltage for driving the first LED to a first power line connected to the first LED among the power lines, and
apply a second voltage for driving the second LED to a second power line connected to the second LED among the power lines, and
wherein the second voltage is different from the first voltage.

2. The display device of claim 1, wherein the LEDs further comprise a third LED,
wherein the first LED is configured to emit a light with a red color,
wherein the second LED is configured to emit a light with a blue color, and
wherein the third LED is configured to emit a light with a green color.

3. The display device of claim 2, wherein the second voltage is greater than the first voltage.

4. The display device of claim 1, wherein the power circuitry is further configured to:
apply, in a first time section, the first voltage to the first power line, and
apply, in a second time section that is different from the first time section, the second voltage to the second power line.

5. The display device of claim 4, wherein the pixel control circuitry is further configured to maintain, in at least a portion of the first time section, a current of the first LED.

6. The display device of claim 5, wherein the pixel control circuitry is further configured to:
maintain the current of the first LED to maintain, in at least the portion of the first time section, intensity of the first LED as intensity associated with a frame image displayed through the display panel.

7. The display device of claim 1, wherein the pixel control circuitry is connected to the cathodes of the LEDs through a control line.

8. The display device of claim 1, wherein the LEDs comprise a plurality of sets of LEDs including a set of the LEDs which are connected to the pixel control circuitry,
wherein the display device further comprises a set of pixel control circuitry including the pixel control circuitry, and
wherein the pixel control circuitry of the set pixel control circuitry are respectively connected to the plurality of sets of the LEDs.

9. A display device comprising:
a display panel;
a backlight panel comprising a plurality of backlight pixels respectively comprising light emitting diodes (LEDs) configured to emit lights with different colors;
a set of pixel control circuitry respectively connected to the plurality of backlight pixels; and
power circuitry connected to a plurality of power lines, wherein the plurality of power lines comprise:
a first power line connected to a first group of LEDs having a first color among the LEDs of the plurality of backlight pixels; and
a second power line connected to a second group of LEDs having a second color among the LEDs of the plurality of backlight pixels, and
wherein the power circuitry is configured to:
apply a first voltage to each of the LEDs of the first group of LEDs through the first power line, and
apply a second voltage to each of the LEDs of the second group of the LEDs through the second power line, and
wherein the second voltage is different from the first voltage.

10. The display device of claim 9, wherein the LEDs of each of the plurality of backlight pixels comprise:
a first LED configured to emit a light with a red color;
a second LED configured to emit a light with a blue color; and
a third LED configured to emit a light with a green color.

11. The display device of claim 10, wherein the first group of the LEDs is configured to emit the light with the red color, and
wherein the second group of the LEDs is configured to emit the light with the blue color.

12. The display device of claim 9, wherein the power circuitry is configured to:
apply, in a first time section, the first voltage to the first power line,
apply, in a second time section that is different from the first time section, the second voltage to the second power line.

13. The display device of claim 12, wherein each of pixel control circuitry of the set of pixel control circuitry is configured to maintain, in at least a portion of the first time section, a current of each of the LEDs of the first group of the LEDs.

14. The display device of claim 12, wherein the plurality of power lines further comprise a third power line connected to a third group of LEDs having a third color among the LEDs of the plurality of backlight pixels, and
wherein the power circuitry is further configured to apply, in a third time section that is different from the first time section and the second time section, a third voltage to the third power line, and
wherein the third voltage is different from the first voltage and the second voltage.

15. The display device of claim 9, wherein each of the pixel control circuitry of the set of the pixel control circuitry is connected to cathodes of the LEDs of a corresponding backlight pixel through a control line.

16. A method of a display device, wherein the display device comprises a backlight panel comprising light emitting diodes (LEDs) which are configured to emit lights with different colors, pixel control circuitry connected to cathodes of the LEDs, and power circuitry connected to power lines respectively connected to anodes of the LEDs, the method comprising:
controlling the power circuitry to apply a first voltage for driving a first LED among the LEDs, to a first power line connected to the first LED among the power lines; and
controlling the power circuitry to apply a second voltage for driving a second LED among the LEDs, to a second power line connected to the second LED among the power lines,
wherein the second voltage is different from the first voltage.

17. The method of claim 16, wherein the first LED is configured to emit a light with a red color,
wherein the second LED is configured to emit a light with a blue color, and wherein a third LED among the LEDs is configured to emit a light with a green color.

18. The method of claim 17, wherein the second voltage greater is than the first voltage.

19. The method of claim 16, wherein the controlling the power circuitry comprises:
controlling the power circuitry to apply, in a first time section, the first voltage to the first power line, and
controlling the power circuitry to apply, in a second time section that is different from the first time section, the second voltage to the second power line.

20. The method of claim 19, wherein the pixel control circuitry is configured to maintain a current of the first LED in at least portion of the first time section.
